(19) United States
(12) Patent Application Publication
(10) Pub. No.: US 2018/0110335 A1
(43) Pub. Date: Apr. 26, 2018

(54) MODULAR ORGANIZATION KIT FOR USE WITH ONE OR MORE ACCESSORIES

(71) Applicant: Kenny O'Hagan, Spiro, OK (US)

(72) Inventor: Kenny O'Hagan, Spiro, OK (US)

(21) Appl. No.: 15/794,733

(22) Filed: Oct. 26, 2017

Related U.S. Application Data
(60) Provisional application No. 62/412,931, filed on Oct. 26, 2016.

(51) Int. Cl. A47C 7/66; A47C 1/11; A47C 7/00; G05G 1/06

(52) U.S. Cl. CPC A47C 7/66; G05G 1/06; A47C 7/004; A47C 1/11

(57) ABSTRACT

A system is provided for organizing accessories. The system includes one or more base assemblies coupleable to a seat pedestal. Each base assembly is adjustable between a disengaged configuration and an engaged configuration. One or more arm assemblies include one or more arm members and one or more connection members coupled to the arm members. A first arm member is coupled to a first base assembly such that the first arm member is rotatable about the seat pedestal when the first base assembly is in the disengaged configuration and securely positioned relative to the seat pedestal to extend radially from the seat pedestal in one of a plurality of directions when the first base assembly is in the engaged configuration. One or more accessories are coupled to the arm assemblies. A first accessory is coupled to a second arm member or a first connection member.

### CROSS-REFERENCE TO RELATED APPLICATION

This application claims the benefit of U.S. Provisional Application No. 62/412,931, filed Oct. 26, 2016.

### BACKGROUND

At least some accessories enable users to perform or more tasks. At least some users may be seated or at least near (e.g., within arm's length) of a chair when looking for one or more accessories to use. Some people's physical limitations find sitting up in a chair may be difficult when the user needs to grasp an item. For those with bad backs, it may be difficult to reach across a desk or a table to grasp an item or an accessory. Additionally, workspace and modular offices in call centers can be crowded, and workers may not have a desk or room in their workstations for items that they may need while working. For example, when styling hair in a salon, the stylist may keep the items on a crowded workspace in front of the client or a movable cart, and the stylist may have to lean over constantly when reaching for items during work. Further, when hunting and fishing, individuals sit quietly in chairs so that prey will not be aware of the hunter's presence. If the person gets up and moves around, for example, to retrieve a beverage, add bait to a hook, grab additional clothing, or reload a firearm or bow, the game may be spooked and move away.

Moreover, bass boats and other boats used in sports fishing typically have chairs which can be rotated on the pedestal. The pedestal allows the fisherman to assume various orientations while fishing. Beverage containers, tackle boxes, and other fishing gear and accessory items which must be maintained close at hand are often placed on the deck near the boat seat. Access to the fishing gear may not always be convenient because the seat may be rotated to a position from which the necessary items cannot be easily reached. In addition, placement of items on the deck tends to unduly clutter, and can result in fishing gear, beverage containers, and other articles being inadvertently kicked or stepped on by persons walking on the deck. This can result in the spilling of liquids, damage to fishing gear and other objects, and possible personal injury.

### SUMMARY

Examples of the disclosure enable one or more accessories to be organized. In one aspect, a system is provided. The system includes one or more base assemblies coupleable to a seat pedestal. Each base assembly of the one or more base assemblies is adjustable between a disengaged configuration and an engaged configuration independent of another base assembly of the one or more base assemblies. One or more arm assemblies include one or more arm members and one or more connection members coupled to the one or more arm members. A first arm member of the one or more arm members is coupled to a first base assembly of the one or more base assemblies such that the first arm member is rotatable about the seat pedestal when the first base assembly is in the disengaged configuration and securely positioned relative to the seat pedestal to extend radially from the seat pedestal in one of a plurality of directions when the first base assembly is in the engaged configuration. One or more accessories are coupled to the one or more arm assemblies. A first accessory of the one or more accessories is coupled to a second arm member of the one or more arm members or a first connection member of the one or more connection members.

In another aspect, a modular organization kit is provided. The modular organization kit includes a first collar member having a knob portion, and a second collar member having a plurality of seat portions. Each seat portion of the plurality of seats is sized to at least partially receive the knob portion. The second collar member is rotatable relative to the first collar member when the knob portion is free from the plurality of seats and securely positioned relative to the first collar member when the knob portion is seated in one of the plurality of seats. A plurality of arm members includes a first arm member. The first arm member has a first end portion and a second end portion. The first end portion is coupleable to the first collar member or the second collar member such that the second end portion is spaced radially from the one of the first collar member or the second collar member, is rotatable relative to the other of the first collar member or the second collar member when the knob portion is free from the plurality of seats, and is securely positioned relative to both the first collar member and the second collar member when the knob portion is seated in one of the plurality of seats.

In yet another aspect, a method is provided for coupling at least one accessory to a seat pedestal. At least one base assembly is coupled to a seat pedestal. Each base assembly is adjustable between a disengaged configuration and an engaged configuration. An arm assembly is coupled to a first base assembly of the at least one base assembly. The arm assembly includes a first arm member rotatable about the seat pedestal when the first base assembly is in the disengaged configuration and securely positioned relative to the seat pedestal to extend radially from the seat pedestal in one of a plurality of directions when the first base assembly is in the engaged configuration. At least one accessory is coupled to the arm assembly.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

### BRIEF DESCRIPTION OF THE DRAWINGS

FIG. 1 is a perspective view of an example system;

FIG. 2 is a front plan view of the system shown in FIG. 1;

FIG. 3 is a side plan view of the system shown in FIG. 1;

FIG. 4 is a side plan view of the system shown in FIG. 1 in a nested configuration;

FIG. 5 is a perspective view of another example system;

FIG. 6 is a perspective view of an example base assembly that may be used with a system, such as the system shown in FIG. 1 or FIG. 5;

FIG. 7 is an upper exploded view of the base assembly shown in FIG. 6;

FIG. 8 is a lower exploded view of the base assembly shown in FIG. 6;

FIG. 9 is a perspective view of an example collar member that may be used with a base assembly, such as the base assembly shown in FIG. 6;

FIG. 10 is a perspective view of another example collar member that may be used with a base assembly, such as the base assembly shown in FIG. 6;

FIG. 11 is a plan view of the collar member shown in FIG. 10;

FIG. 12 is a plan view of an example arm assembly that may be used with the system shown in FIG. 1 or FIG. 5;

FIG. 13 is a plan view of an example arm member that may be used with an arm assembly, such as the arm assembly shown in FIG. 12;

FIG. 14 is a plan view of another example arm member that may be used with an arm assembly, such as the arm assembly shown in FIG. 12;

FIG. 15 is a perspective view of the arm member shown in FIG. 14;

FIG. 16 is a plan view of an example accessory that may be used with a system, such as the system shown in FIG. 1 or FIG. 5;

FIG. 17 is a perspective view of an example accessory that may be used with a system, such as the system shown in FIG. 1 or FIG. 5;

FIG. 18 is a plan view of the accessory shown in FIG. 17 in an expanded configuration;

FIG. 19 is a plan view of the accessory shown in FIG. 17 in a retracted configuration;

FIG. 20 is a plan view of an example accessory that may be used with a system, such as the system shown in FIG. 1 or FIG. 5;

FIG. 21 is a perspective view of the accessory shown in FIG. 20;

FIG. 22 is a perspective view of an example accessory that may be used with a system, such as the system shown in FIG. 1 or FIG. 5;

FIG. 23 is a side view of the accessory shown in FIG. 22;

FIG. 24 is a front view of the accessory shown in FIG. 22; and

FIG. 25 is a flowchart illustrating an example method of coupling at least one accessory to a seat pedestal using a system, such as the system shown in FIG. 1 or FIG. 5.

Corresponding reference characters indicate corresponding parts throughout the drawings.

### DETAILED DESCRIPTION

The subject matter described herein relates generally to coupling mechanisms and, more specifically, to modular organization kits for use with one or more accessories. Examples of the disclosure may be used to render one or more accessories easily accessible to a user. One or more accessories may be accessed, for example, while a user is in or adjacent a seat. The accessories may be coupled to one or more independently swiveling arm assemblies that are configured to provide convenient access for the user. The examples described herein reduce installation, operating, maintenance, and/or replacement costs of an accessory system while increasing efficiency and safety for use of the accessory system. It should be understood that the descriptions and figures are for example only, and that the examples may be used with a seat pedestal for any type of seat, including, without limitation, salon chairs, office chairs, boat chairs, and hunting chairs.

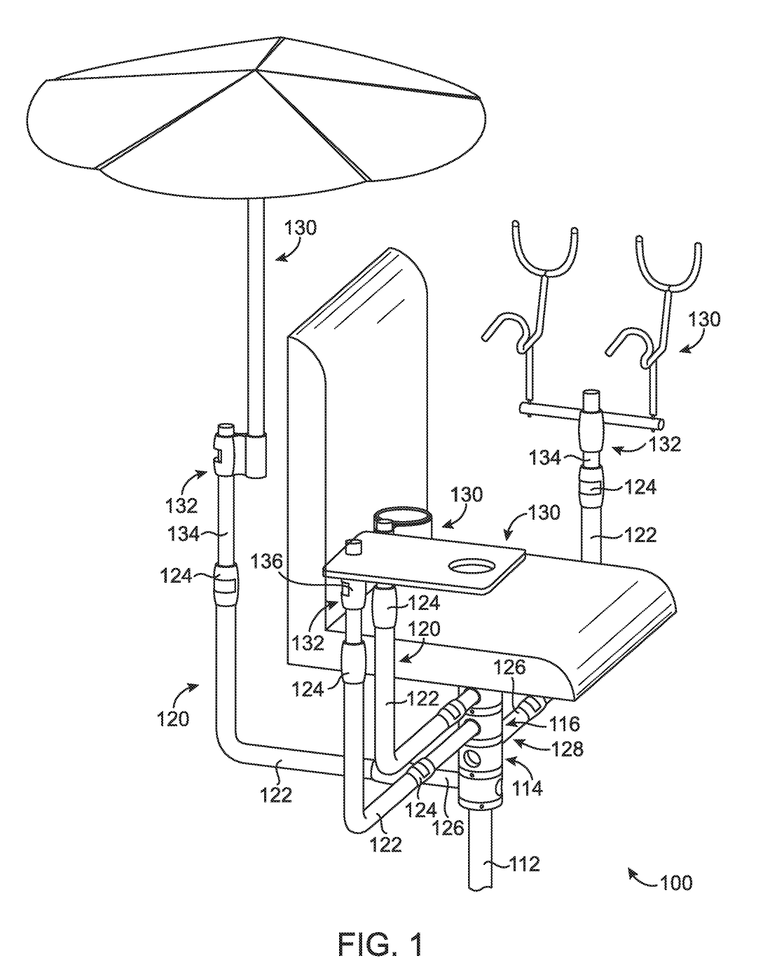

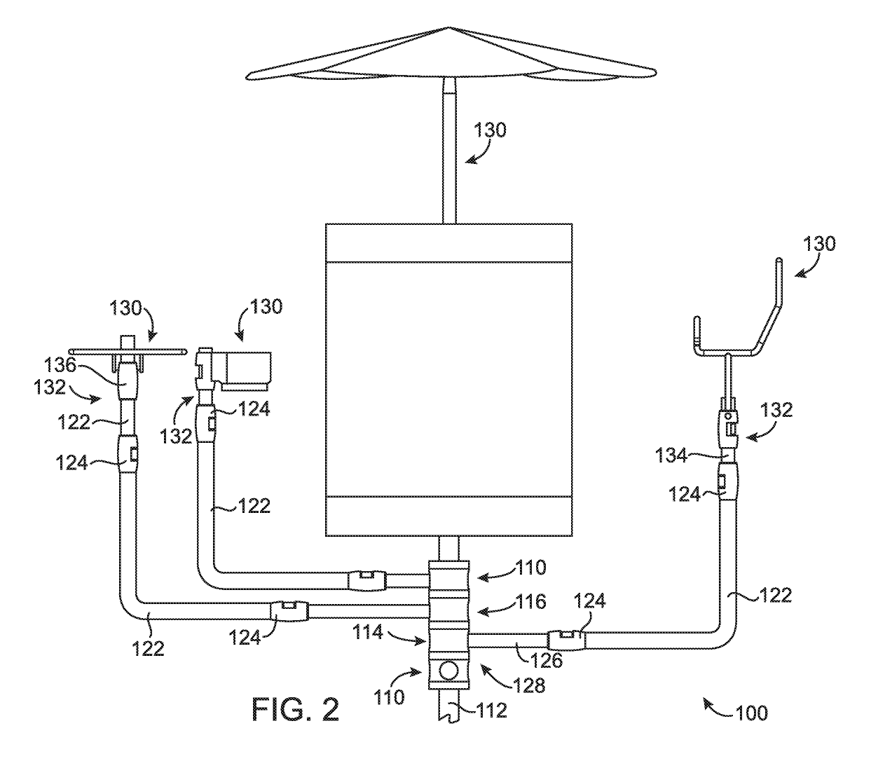

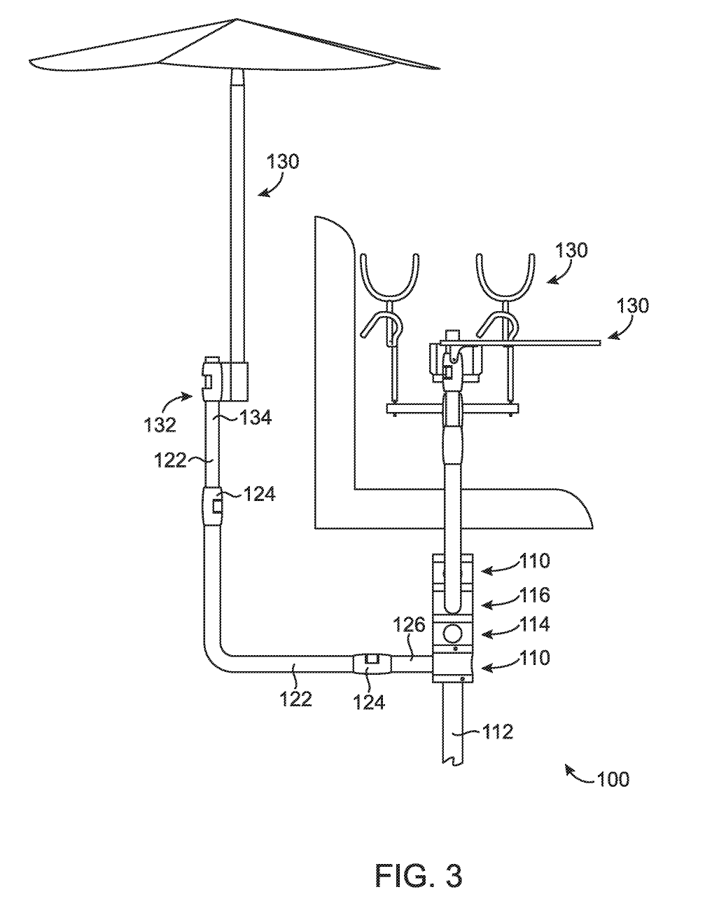

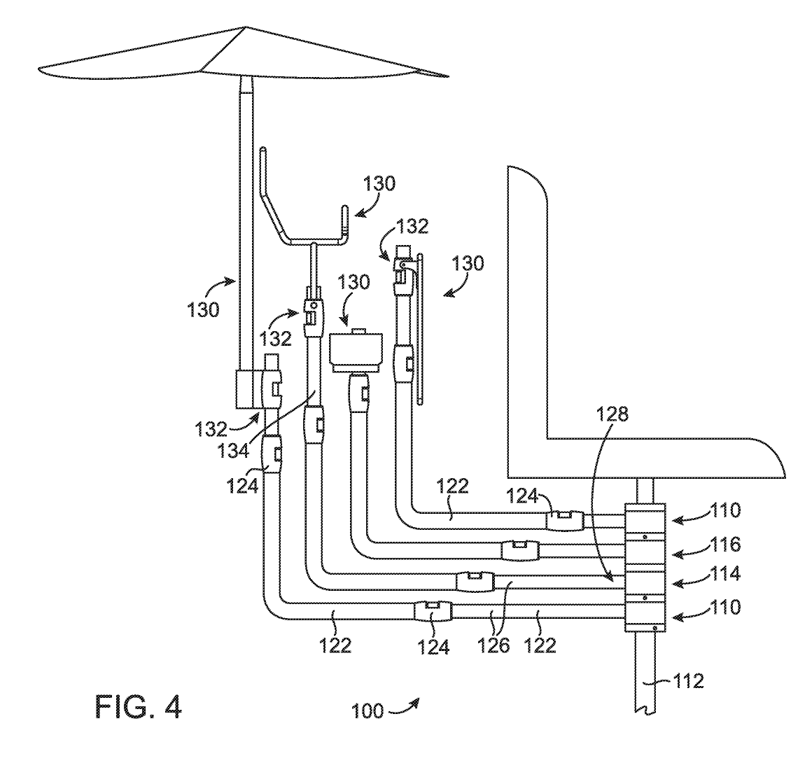

FIGS. 1-3 shows an example system 100 in an expanded configuration. FIG. 4 shows the system 100 in a nested configuration. The system 100 includes one or more base assemblies 110 coupled to a seat pedestal 112. Each base assembly 110 (e.g., a first base assembly 114) is adjustable between a disengaged configuration and an engaged configuration independent of the other base assemblies 110 (e.g., a second base assembly 116). Each base assembly 110 is coupled to one or more arm assemblies 120. Each arm assembly 120 includes one or more arm members 122 and one or more connection members 124 coupled to the arm members 122. A first arm member 126 of each arm assembly 120 is coupled to a respective base assembly 110 at a proximal end portion 128 (e.g., a first end portion) of the arm assembly 120. The first arm member 126 may extend from the base assembly 110 and/or seat pedestal 112, for example, in a direction that is substantially perpendicular to the seat pedestal 112.

When a base assembly 110 is in the disengaged configuration, the first arm member 126 coupled to the base assembly 110 may be rotated about the seat pedestal 112 independent of the other first arm members 126 and their corresponding arm assemblies 120. With each first arm member 126 being independently rotatable about the seat pedestal 112, the arm assemblies 120 may be selectively adjusted between a nested arrangement, in which the first arm members 126 are oriented to extend from the base assembly 110 and/or seat pedestal 112 in a common or the same direction as shown, for example, in FIG. 4, and an expanded arrangement, in which the first arm members 126 are oriented to extend from the base assembly 110 and/or seat pedestal 112 in a plurality of directions as shown, for example, in FIGS. 1, 2, and 3. The arm assemblies 120 may extend various lengths from the seat pedestal 112, for example, to enable the arm assemblies 120 to be nested. When the base assembly 110 is in the engaged configuration, the first arm member 126 coupled to the base assembly 110 is securely positioned relative to the seat pedestal 112 such that the first arm member 126 is oriented to extend radially from the base assembly 110 and/or seat pedestal 112 in one of a plurality of directions.

One or more accessories 130 are coupled to the arm assemblies 120 at the distal end portions 132 (e.g., a second end portion) of the arm assemblies 120. An accessory 130 may be coupled to an arm member 122 other than the first arm member 126 (e.g., a second arm member 134). The second arm member 134 may extend, for example, in a direction that is substantially perpendicular to the seat pedestal 112. In some examples, a connection member 124 (e.g., a first connection member 136) connects the accessory 130 to the arm assembly 120.

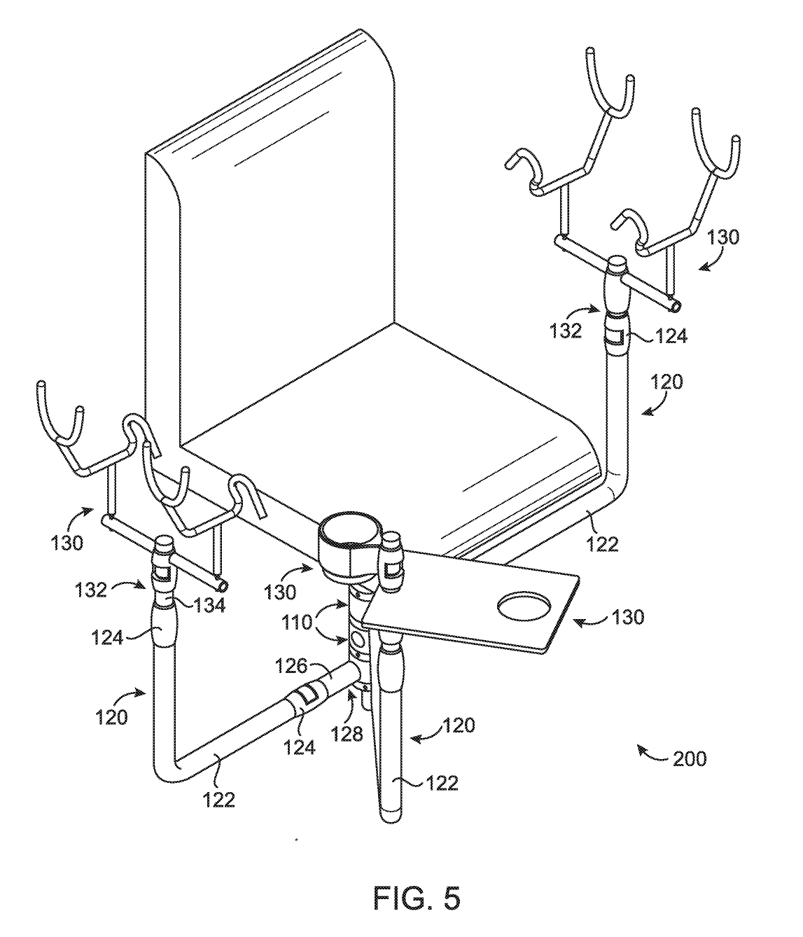

The system 100 may include any quantity and/or combination of base assemblies 110, arm assemblies 120, and/or accessories 130 that enable the accessories 130 to be coupled to a rod or post (e.g., seat pedestal 112). FIG. 5, for example, shows another example system 200 that is substantially similar to the system 100. Like the system 100, the system 200 includes one or more base assemblies 110, one or more arm assemblies 120 coupled to the base assemblies 110, and one or more accessories 130 coupled to the arm assemblies 120. Unlike the system 100, which includes four arm assemblies 120, the system 200 includes three arm assemblies 120. Moreover, while the quantity of accessories 130 are the same, the combination of accessories 130 are different. The accessories 130 included in the system 100 includes one fillet board, one cup holder, one rod holder system, and one umbrella, where the accessories 130 included in the system 200 includes one fillet board, one cup holder, and two rod holder systems.

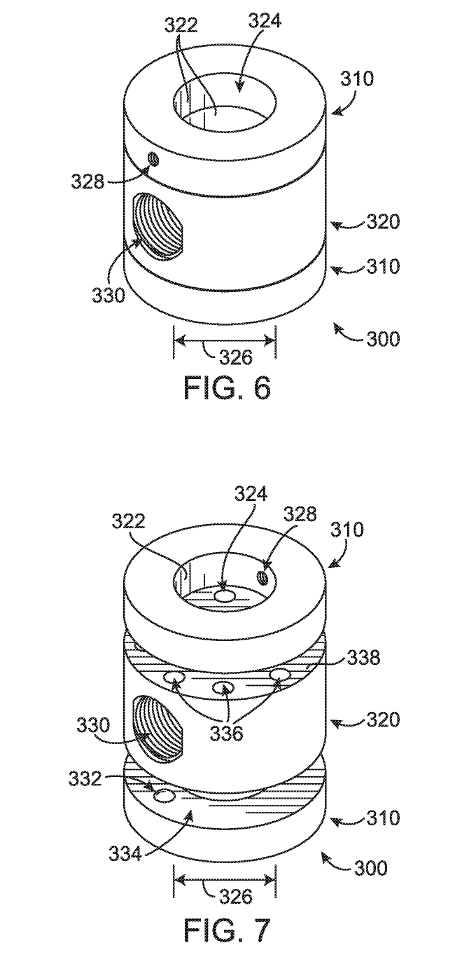

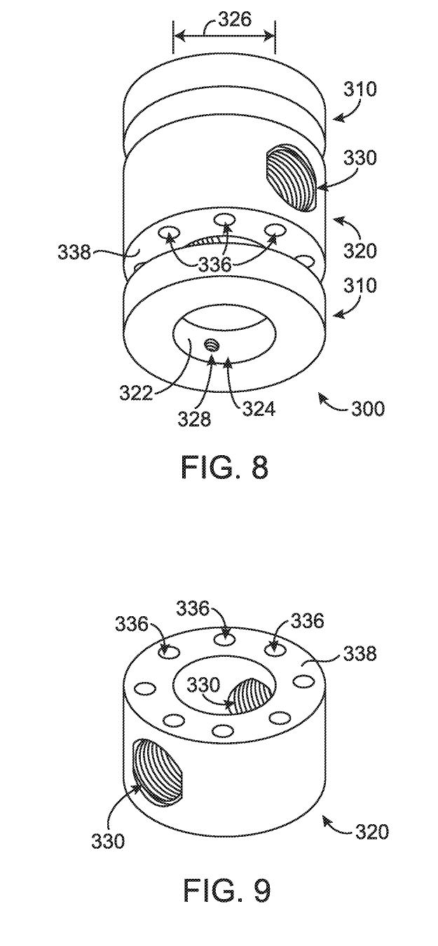

FIGS. 6-8 show an example base assembly 300 (e.g., base assembly 110, first base assembly 114, second base assembly 116) that may be used with the system 100 and/or system 200. The base assembly 300 includes one or more first collar members 310 and one or more second collar members 320 configured to engage the first collar members 310. In some examples, the first collar members 310 and/or second collar members 320 have an inner surface 322 that defines an opening 324 extending longitudinally through the base assembly 300. The inner surface 322 has a width or diameter 326 that allows a rod or post (e.g., seat pedestal 112) to extend longitudinally through the base assembly 300. In this manner, the base assembly 300 may be coupled to the seat pedestal 112 such that the first collar members 310 and/or second collar members 320 are slidable along and/or rotatable about a longitudinal axis of the seat pedestal 112.

A first collar member 310 (e.g., an upper collar member, a lower collar member) has an opening 328 defined radially therethrough. The opening 328 may be sized, for example, to at least partially receive a securing mechanism (not shown). The securing mechanism may be extended radially inward through the opening 328 to engage the seat pedestal 112 for securing a position and/or orientation of the first collar member 310. In this manner, when the securing mechanism is engaged with the seat pedestal 112, the securing mechanism resists and/or restricts a movement of the first collar member 310 along and/or about the longitudinal axis of the seat pedestal 112.

A second collar member 320 (e.g., a middle collar member) has an opening 330 defined radially therethrough. The opening 330 may be sized, for example, to at least partially receive the first arm member 126. A proximal end of the first arm member 126 may be extended radially inward through the opening 330 for securely coupling the arm assembly 120 to the base assembly 300. In this manner, when the arm assembly 120 is coupled to the base assembly 300, the first arm member 126 may be selectively moved along and/or about the longitudinal axis of the seat pedestal 112.

As shown in FIG. 9, the second collar member 320 may include a plurality of openings 330 for receiving a plurality of first arm members 126. The openings 330 may be positioned and/or oriented in any arrangement that enables the first arm members 126 to be coupled to the base assembly 300. FIG. 9, for example, shows openings 330 spaced 180 degrees from each other (i.e., the opening 330 are on opposite sides of the second collar member 320 and aligned with each other). Additionally, the openings 330 may have any other size, shape, and/or configuration that enables the first arm members 126 to be coupled to the base assembly 300. The surface defining the openings 330 shown in FIGS. 6-9, for example, is threaded to enable the first arm member 126 to be threadably coupled to the second collar member 320. Alternatively, the first arm member 126 may be coupled to the second collar member 320 using a slip fit, a press fit, and the like to enable a quick disconnect fitting.

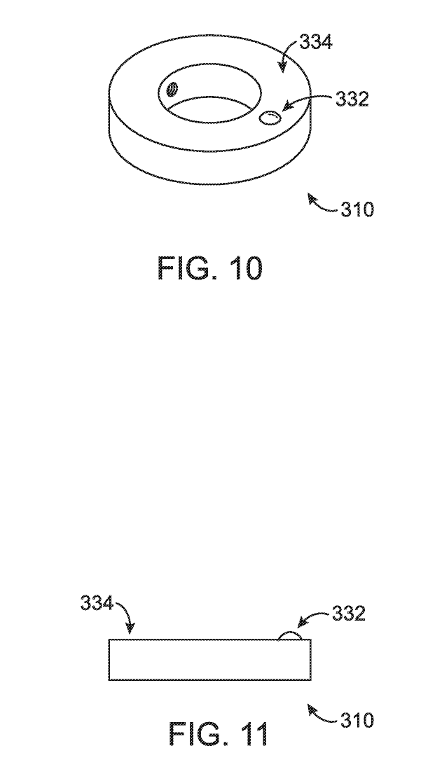

The second collar member 320 is configured to selectively engage one or more first collar members 310 for adjusting the base assembly 300 between a disengaged configuration and an engaged configuration. As shown in FIGS. 7, 10, and 11, a first collar member 310 may have one or more knob portions 332 protruding from a relatively planar portion 334. The knob portions 332 may be, for example, at an upper surface of the lower collar member (e.g., a first collar member 310) and/or a lower surface of the upper collar member (e.g., another first collar member 310). Knob portions 332 may be or include, for example, a bulge, a stump, a protrusion, and the like. As shown in FIGS. 7, 8, and 9, a second collar member 320 may have a plurality of seat portions 336 depressed from a relatively planar portion 338. The seat portions 336 may be at a lower surface and/or an upper surface of the middle collar member (e.g., a second collar member 320). Seat portions 336 may be or include, for example, an indentation, a groove, a divot, and the like. Additionally or alternatively, one or more first collar members 310 may have one or more seat portions 336 and/or one or more second collar members 320 may have one or more knob portions 332.

Each seat portion 336 may be sized to at least partially receive the knob portion 332. In this manner, the middle collar member may be engaged with the lower collar member and/or the upper collar member, as shown in FIG. 6, when a distance between the upper surface of the lower collar member and the lower surface of the middle collar member and/or between the lower surface of the upper collar member and the upper surface of the middle collar member is decreased and the knob portion 332 is urged towards and/or received in one of the seat portions 336.

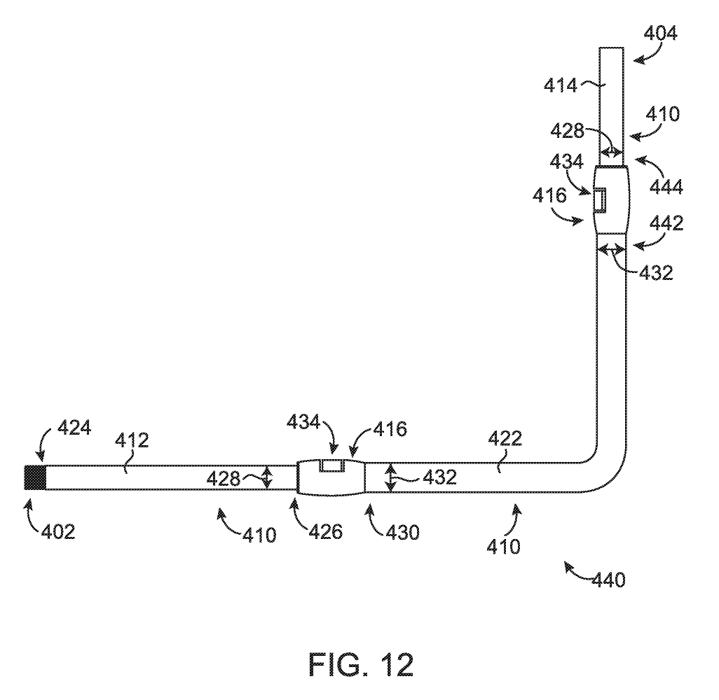

FIG. 12 shows an example arm assembly 400 (e.g., arm assembly 120) that is coupleable to the base assembly 300. The arm assembly 400 extends between a proximal end portion 402 of the arm assembly 400 (e.g., first end portion 128) and a distal end portion 404 of the arm assembly 400 (e.g., second end portion 132). The proximal end portion 402 may be directly connected to the base assembly 300, for example, and the distal end portion 404 may be directly connected to one or more accessories 130.

The arm assembly 400 include a plurality of arm members 410 (e.g., arm members 122) that are assembled in a modular fashion to produce various configurations of the arm assembly 400. In some examples, a first arm member 412 (e.g., first arm member 126) is at the proximal end portion 402 of the arm assembly 400 for coupling the arm assembly 400 to the base assembly 300, and a second arm member 414 (e.g., second arm member 134) is at the distal end portion 404 of the arm assembly 400 for coupling the arm assembly 400 to one or more accessories 130. Alternatively, a single arm member (e.g., first arm member 412) may be at the proximal end portion 402 of the arm assembly 400 and at the distal end portion 404 of the arm assembly 400.

One or more connection members 416 may be used to couple an arm member 410 to another object. A connection member at the distal end portion 404 of the arm assembly 400 (e.g., a first connection member), for example, may be used to couple the arm assembly 400 to one or more accessories 130. As shown in FIG. 12, one or more connection members 416 (e.g., a second connection member) are used to couple the first arm member 412 and/or second arm member 414 to a third arm member 422 extending between the first arm member 412 and the second arm member 414.

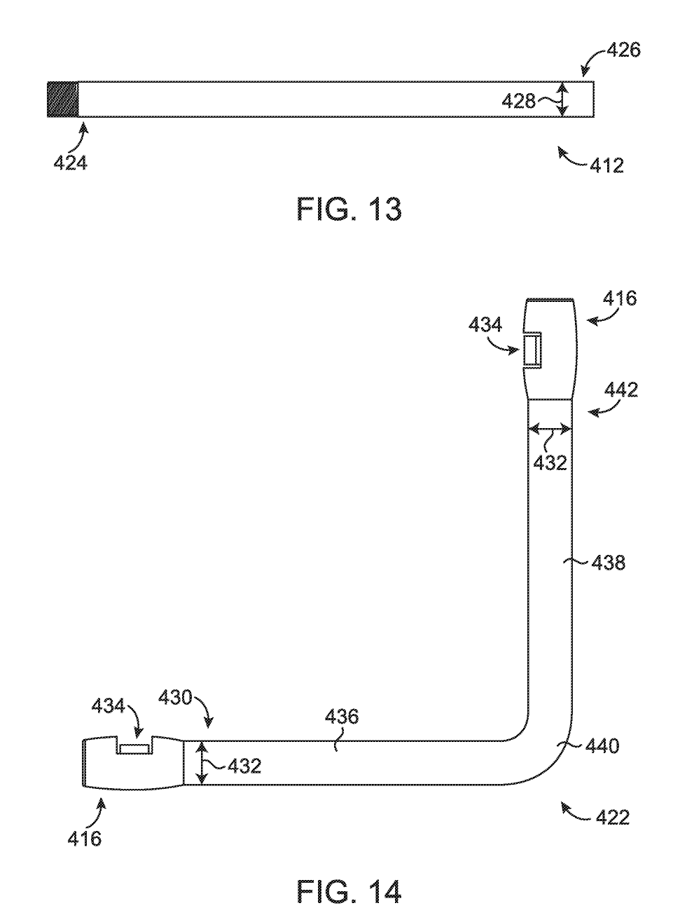

In some examples, a proximal end portion 424 of the first arm member 412 is threaded for threadably coupling the first arm member 412 to the second collar member 320 (shown, e.g., in FIGS. 6-9). The first arm member 412 may be positioned to extend in a direction substantially perpendicular to a seat pedestal 112 coupled to the base assembly 300. As shown in FIGS. 12 and 13, the first arm member 412 has an elongated body with a generally cylindrical or tubular-shaped profile.

In some examples, the first arm member 412 is telescopically coupled to the third arm member 422. Alternatively, the first arm member 412 may be fixedly and/or hingedly coupled to the third arm member 422. A distal end portion 426 of the first arm member 412 may have a first width or diameter 428, and a proximal end portion 430 of the third arm member 422 may have a second width or diameter 432 different from the first diameter 428. For example, the first diameter 428 may be 0.75 inches, and the second diameter 432 may be 1.0 inches. In this manner, the distal end portion 426 of the first arm member 412 may be longitudinally movable in a cavity defined by an inner surface of the proximal end portion 430 of the third arm member 422 such that the arm members 410 (i.e., first arm member 412, third arm member 422) are movable between an expanded configuration and a contracted configuration. Alternatively, the first diameter 428 may be larger than the second diameter 432 such that the proximal end portion 430 of the third arm member 422 is longitudinally movable in a cavity defined by an inner surface of the distal end portion 426 of the first arm member 412.

A connection member 416 at the proximal end portion 430 of the third arm member 422 and/or the distal end portion 426 of the first arm member 412 enables the third arm member 422 to be securely coupled to the first arm member 412. Each connection member 416 (e.g., first connection member, second connection member) may include, for example, a clamp mechanism 434 that is movable relative to an outer surface of an object being coupled using the connection member 416 (e.g., arm member 410, accessory 130) for selectively engaging the object. The clamp mechanism 434 is moved toward and/or applies a first force on the object when the connection member 416 is in the engaged configuration. In this manner, the connection member 416 resists and/or restricts a relative movement of the objects being coupled using the connection member 416 such that the objects are securely positioned relative to each other when the connection member 416 is in the engaged configuration. On the other hand, the clamp mechanism 434 is moved away and/or applies a second force on the object less than the first force (including no force) when the connection member 416 is in the disengaged configuration. In this manner, the connection member 416 allows a relative movement of the objects coupled using the connection member 416 when the connection member 416 is in the disengaged configuration.

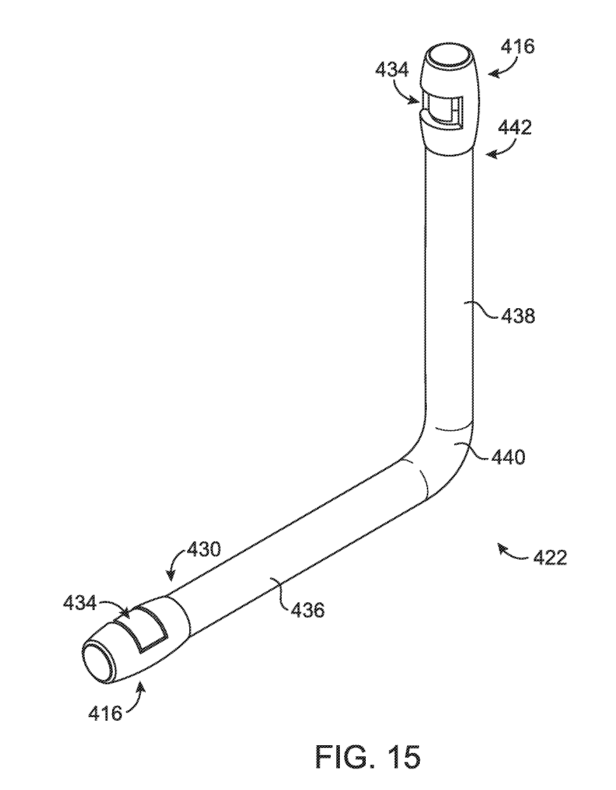

As shown in FIGS. 14 and 15, the third arm member 422 has a first elongated portion 436, a second elongated portion 438, and a joint portion 440 between the first elongated portion 436 and the second elongated portion 438. The third arm member 422 has a bent or angled body with a generally cylindrical or tubular-shaped profile. The second elongated portion 438 may be perpendicular to the first elongated portion 436. Alternatively, the second elongated portion 438 may extend from the first elongated portion 436 at any angle that enables the arm assembly 400 to function as described herein. In some examples, the joint portion 440 may be hinged to allow the third arm member 422 to be selectively bent at one or more desired angles.

In some examples, the third arm member 422 is telescopically coupled to the second arm member 414. Alternatively, the third arm member 422 may be fixedly and/or hingedly coupled to the second arm member 414. A distal end portion 442 of the third arm member 422 may have one width or diameter (e.g., second diameter 432), and a proximal end portion 444 of the second arm member 414 may have another width or diameter (e.g., first diameter 428). In this manner, the proximal end portion 444 of the second arm member 414 may be longitudinally movable in a cavity defined by an inner surface of the distal end portion 442 of the third arm member 422 such that the arm members 410 (i.e., second arm member 414, third arm member 422) are movable between an expanded configuration and a contracted configuration. Alternatively, the distal end portion 442 of the third arm member 422 is longitudinally movable in a cavity defined by an inner surface of the proximal end portion 444 of the second arm member 414. A connection member 416 at the distal end portion 442 of the third arm member 422 and/or the proximal end portion 444 of the second arm member 414 enables the third arm member 422 to be securely coupled to the second arm member 414.

The second arm member 414 may be positioned to extend in a direction substantially parallel to the second elongated portion 438 and/or to the seat pedestal 112, and/or substantially perpendicular to the first elongated portion 436 and/or to the first arm member 412. The second arm member 414 has an elongated body with a generally cylindrical or tubular-shaped profile.

The arm assembly 400 may include any quantity and/or combination of arm members 410 and/or connection members 416 that enables the arm assembly 400 to function as described herein. FIG. 13 shows one example arm member 410 (e.g., first arm member 412) that may be included in the arm assembly 400, and FIGS. 14 and 15 show another example arm member 410 (e.g., third arm member 422) that may be included in the arm assembly 400 and a plurality of connection members 416 coupled to the arm member 410.

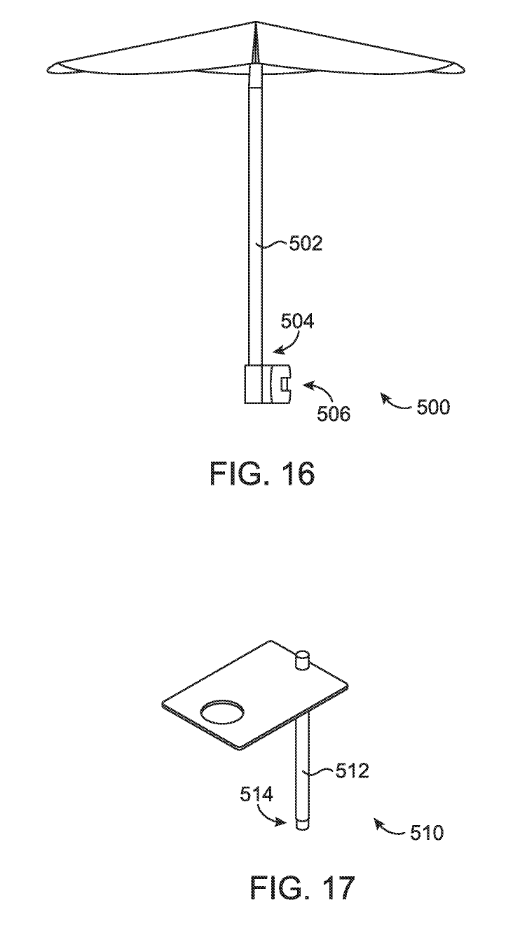

FIGS. 16-24 show various example accessories 130 that may be coupled to an arm member 122 (e.g., second arm member 134) and/or a connection member 124 (e.g., connection member 136).

FIG. 16 shows one example accessory 130 (e.g., an umbrella 500). The umbrella 500 includes an elongated body 502 with a generally cylindrical or tubular-shaped profile, and a connection member 506 at a proximal end 504 of the elongated body 502. The connection member 506 enables the umbrella 500 to be coupled to an arm member 122.

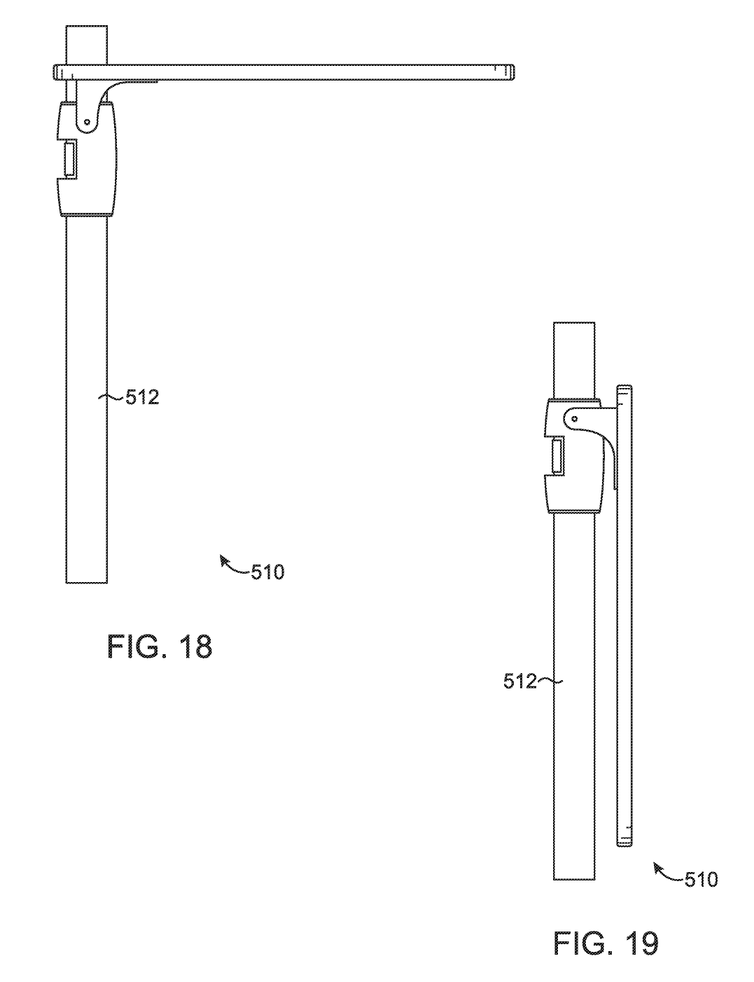

FIGS. 17-19 show another example accessory 130 (e.g., a fillet board 510). The fillet board 510 includes an elongated body 512 with a generally cylindrical or tubular-shaped profile. The elongated body 512 may have, for example, the first diameter 428 such that a proximal end portion 514 of the elongated body 512 may be positioned in a distal end portion of an arm member 122 (e.g., distal end portion 474) for coupling the fillet board 510 to the arm member 122. FIG. 18 shows the fillet board 510 in an deployed configuration, and FIG. 19 shows the fillet board 510 in a folded configuration.

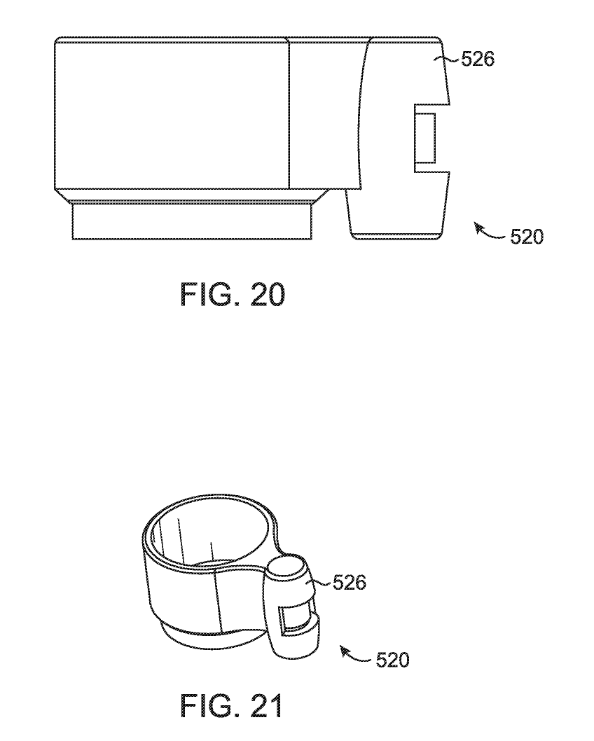

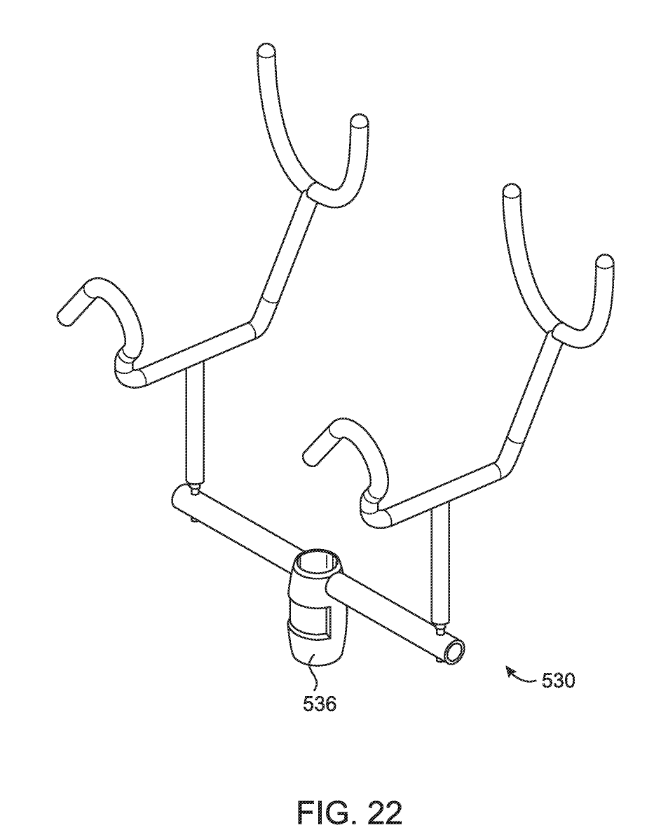

FIGS. 20 and 21 show another example accessory 130 (e.g., a cup holder 520). The cup holder 520 includes a connection member 526 that enables the cup holder 520 to be coupled to an arm member 122.

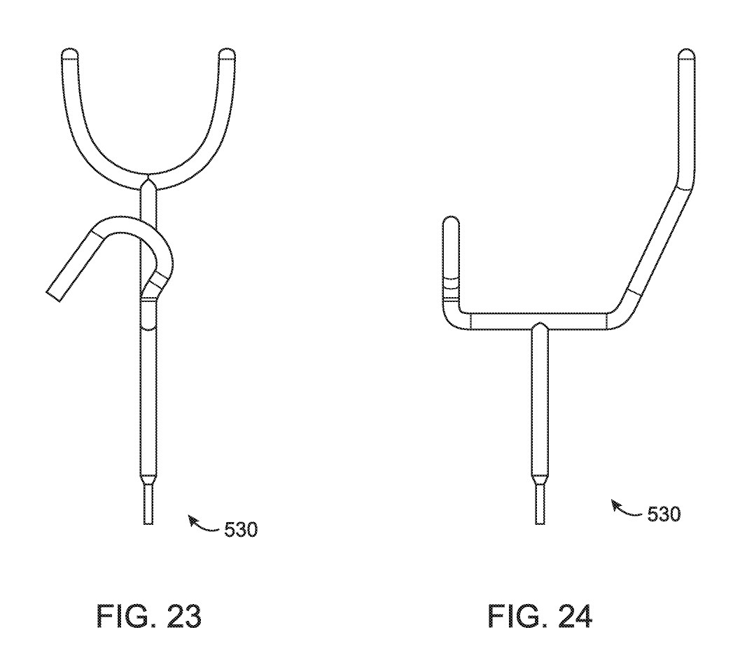

FIG. 22 shows another example accessory 130 (e.g., a rod holder 530). The rod holder 530 includes a connection member 536 that enables the rod holder 530 to be coupled to an arm member 122. FIGS. 23 and 24 show an upper portion of the rod holder 530.

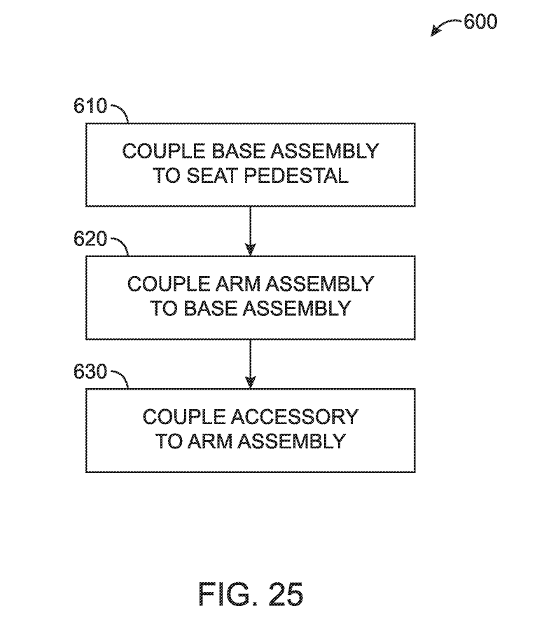

FIG. 25 is a flowchart for a method 600 of coupling at least one accessory 130 to a seat pedestal 112. The seat pedestal 112 may support a chair and couple the chair to a bass boat or other sports fishing boat having a deck. The chair may include a seat and a back rest, which may be connected by a pair of folding brackets. The back rest is normally in an upright position, but the folding brackets are configured to allow the back rest to fold down on top of the seat when not in use. The bottom of the seat pedestal 112 may be secured to a flat mounting plate, which has bolt holes that allow it to be bolted to the deck.

At least one base assembly 110 (e.g., first base assembly 114) is coupled to the seat pedestal 112 at operation 610. The base assembly 110 includes a top surface, a bottom surface, an outer wall extending between the top surface and the bottom surface, and an inner wall extending between the top surface and the bottom surface. The inner wall defines an open channel having a diameter. The diameter of the open channel is sized and shaped to circumscribe the seat pedestal 112 for removably coupling the base assembly 110 to the seat pedestal 112. The inner wall may facilitate rotational movement of the base assembly 110 about the seat pedestal 112.

The first base assembly 114 may include a securing mechanism and a collar member (e.g., first collar member 310, second collar member 320) having an opening 324 defined radially therethrough. The opening 324 is sized to at least partially receive the securing mechanism for securely coupling the collar member to the seat pedestal 112. The securing mechanism may be or include, for example, a screw and/or a bolt. A tool (not shown) such as, for example, an Allen wrench is configured to move the securing mechanism through the opening 324 and/or against the seat pedestal 112 to fix or lock the base assembly 110 against the seat pedestal 112 to inhibit and/or eliminate rotational movement of the base assembly 110 relative to the seat pedestal 112.

The collar member may be configured to engage another collar member (e.g., first collar member 310, second collar member 320). Each base assembly 110 is adjustable between a disengaged configuration and an engaged configuration independent of the other base assemblies 110.

An arm assembly 120 is coupled to the first base assembly 114 at operation 620. The arm assembly 120 is modular and may accommodate various combinations of arm members 122 and/or connection members 124. In some examples, the arm assembly 120 includes a first arm member 126 that is rotatable about the seat pedestal 112 when the first base assembly 114 is in the disengaged configuration and is securely positioned relative to the seat pedestal 112 to extend radially from the seat pedestal 112 in one of a plurality of directions when the first base assembly 114 is in the engaged configuration.

The arm assembly 120 may include a first segment, a second segment, and a connector (e.g., connection member 124) removably coupling the first segment to the second segment. In some examples, the arm assembly 120 includes a second arm member 134 at a distal end portion 132 of the arm assembly 120, and a third arm member (e.g., third arm member 422) between the first arm member 126 and the second arm member 134. The first arm member 126 may be, for example, perpendicular to the seat pedestal 112, and the second arm member 134 may be parallel to the seat pedestal 112. Each arm member 122 is configured to removably couple to another arm member 122 and/or to a connection member 124 using, for example, a threaded connection, a pressure fit, a telescopic connection, and/or a hinged connection.

Additionally, the system 100 may include one or more arm assemblies 120 coupled to one or more base assemblies 110 that are coupled to the seat pedestal 112. One arm assembly 120 may include, for example, its first arm member 126 having a first length, and another arm assembly 120 may have its first arm member 126 having a second length that allows the arm assemblies 120 to be nested. The nested configuration facilitates storage of the arm assemblies 120. The different lengths of the first arm members 126 allow the accessories 130 coupled to the arm assemblies 120 to be positioned such that the accessories 130 do not interfere and/or touch one another for storage and organizational purposes. The arm assemblies 120 are configured to rotate about the seat pedestal 112 (e.g., in a clockwise or counter-clockwise direction) between a first position and a second position.

Additionally, in some examples, each arm assembly 120 may be expanded and/or contracted to a desired length. A first arm member 126, for example, may be telescopically expanded and/or contracted relative to another arm member 122 and/or connection member 124 coupled to the first arm member 126 for expanding and/or contracting the arm assembly 120. Expansion and/or contraction of the arm assemblies 120 facilitates a storage and/or use position such that an accessory 130 coupled to the arm assembly 120 may be moved toward or away from a user.

At least one accessory 130 is coupled to the arm assembly 120 at operation 630. A first accessory 130 may be coupled, for example, to the second arm member 134 and/or to a connection member 124 at the distal end portion 132 of the arm assembly 120. Each connection member 124 may be adjustable between a disengaged configuration and an engaged configuration independent of the other connection members 124. Example accessories 130 include, for example, a fishing pole, a cable, a flashlight, an umbrella, a hunting item, an office item, and a salon item. In some examples, at least a portion of the arm assembly 120 is color coded relative to the particular accessory 130 to facilitate locating and/or matching the accessory 130 with the appropriate arm assembly 120.

During an example use of the system 100, a user may remove a seat from a seat pedestal 112 to expose the top of the seat pedestal 112. The user may couple one or more base assemblies 110 to the seat pedestal 112 by sliding the base assemblies 110 downward and along the seat pedestal 112. Each base assembly 110 may be secured at a desired position along the seat pedestal 112. For example, the user may insert the securing mechanism through the opening 324 and/or against the seat pedestal 112 to fix or lock the base assembly 110 in place relative to the seat pedestal 112.

With the base assemblies 110 in place, one or more arm assemblies 120 may be coupled to the base assemblies 110. The arm assemblies 120 may have any combination of arm members 122 and/or connection members 124 that allows the user to selectively position one or more accessories 130 in a desired position. With the accessories 130 coupled to the arm assemblies 120, the accessories 130 may be efficiently and conveniently moved for storage and/or use (e.g., in the nested arrangement, in the expanded arrangement). For example, the arm assemblies 120 may be moved towards the nested arrangement to store the accessories 130 behind the back rest. On the other hand, the arm assemblies 120 may be moved toward the expanded arrangement to facilitate convenient and efficient access to the accessories 130. While the user is seated in the chair, the user may rotate in the chair and/or rotate the arm assemblies 120 to access a desired combination of accessories 130. The positions of the arm assemblies 120 are adjustable to selectively move one or more accessories 130 closer in or further out, left or right, up or down, depending on the user's preference or need for convenience.

Examples of the modular organization kits are described above in detail. The organization kits are not limited to the specific examples described herein, but rather, components of the accessory system and/or steps of the methods may be utilized independently and separately from other components and/or steps described herein. For example, the systems may also be used in combination with other systems and methods, and is not limited to practice with only the examples as described herein. Rather, the examples can be implemented and utilized in connection with many other applications such as, but not limited to, salon chairs, office chairs, and hunting chairs.

When introducing elements of aspects of the disclosure or the examples thereof, the articles “a,” “an,” “the,” and “said” are intended to mean that there are one or more of the elements. Furthermore, references to an “embodiment” or “example” of the present disclosure are not intended to be interpreted as excluding the existence of additional embodiments or examples that also incorporate the recited features. The terms “comprising,” “including,” and “having” are intended to be inclusive and mean that there may be additional elements other than the listed elements. The phrase “one or more of the following: A, B, and C” means “at least one of A and/or at least one of B and/or at least one of C.”

Although specific features of various examples of the disclosure may be shown in some drawings and not in others, this is for convenience only. In accordance with the principles of the disclosure, any feature of a drawing may be referenced and/or claimed in combination with any feature of any other drawing.

This written description uses examples to disclose the invention and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal language of the claims.

What is claimed is:

1. A system comprising:
one or more base assemblies coupleable to a seat pedestal, each base assembly of the one or more base assemblies adjustable between a disengaged configuration and an engaged configuration independent of another base assembly of the one or more base assemblies;
one or more arm assemblies comprising one or more arm members and one or more connection members coupled to the one or more arm members, a first arm member of the one or more arm members coupled to a first base assembly of the one or more base assemblies such that the first arm member is rotatable about the seat pedestal when the first base assembly is in the disengaged configuration and securely positioned relative to the seat pedestal to extend radially from the seat pedestal in one of a plurality of directions when the first base assembly is in the engaged configuration; and
one or more accessories coupled to the one or more arm assemblies, a first accessory of the one or more accessories coupled to one of a second arm member of the one or more arm members or a first connection member of the one or more connection members.

2. The system of claim 1, wherein the first base assembly comprises:
a securing mechanism; and
a collar member having an opening defined radially therethrough, the opening sized to at least partially receive the securing mechanism.

3. The system of claim 1, wherein the first base assembly comprises:
a first collar member; and
a second collar member configured to engage the first collar member.

4. The system of claim 1, wherein the first base assembly comprises:
a first collar member having a knob portion; and
a second collar member having a plurality of seat portions, each seat portion of the plurality of seats sized to at least partially receive the knob portion.

5. The system of claim 1, wherein the first base assembly includes a collar member having an opening defined radially therethrough, the opening sized to at least partially receive the first arm member.

6. The system of claim 1, wherein the first arm member is substantially perpendicular to the seat pedestal.

7. The system of claim 1, wherein the second arm member is substantially parallel to the seat pedestal.

8. The system of claim 1, wherein a third arm member of the one or more arm members has a first elongated portion, a second elongated portion, and a joint portion between the first elongated portion and the second elongated portion.

9. The system of claim 1, wherein a second connection member of the one or more connection members couples the first arm member with a third arm member of the one or more arm members.

10. The system of claim 1, wherein a second connection member of the one or more connection members couples the second arm member with a third arm member of the one or more arm members.

11. The system of claim 1, wherein a third arm member of the one or more arm members is fixedly coupled to one or more of the first arm member or the second arm member.

12. The system of claim 1, wherein a third arm member of the one or more arm members is telescopically coupled to one or more of the first arm member or the second arm member.

13. The system of claim 1, wherein a third arm member of the one or more arm members is hingedly coupled to one or more of the first arm member or the second arm member.

14. The system of claim 1, wherein the first arm member has a first length and another arm member of the one or more arm members has a second length different from the first length, the other arm member coupled to a second base assembly of the one or more base assemblies such that the other arm member is rotatable about the seat pedestal when the second base assembly is in the disengaged configuration and securely positioned relative to the seat pedestal to extend radially from the seat pedestal in one of the plurality of directions when the second base assembly is in the engaged configuration.

15. The system of claim 1, wherein the one or more arm assemblies are adjustable between a nested arrangement and an expanded arrangement.

16. The system of claim 1, wherein each connection member of the one or more connection members is adjustable between a disengaged configuration and an engaged configuration independent of another connection member of the one or more connection members.

17. A modular organization kit comprising:
a first collar member having a knob portion;
a second collar member having a plurality of seat portions, each seat portion of the plurality of seats sized to at least partially receive the knob portion, the second collar member rotatable relative to the first collar member when the knob portion is free from the plurality of seats and securely positioned relative to the first collar member when the knob portion is seated in one of the plurality of seats;
a plurality of arm members including a first arm member, the first arm member having a first end portion and a second end portion, the first end portion coupleable to one of the first collar member or the second collar member such that the second end portion is spaced radially from the one of the first collar member or the second collar member, is rotatable relative to the other of the first collar member or the second collar member when the knob portion is free from the plurality of seats, and is securely positioned relative to both the first collar member and the second collar member when the knob portion is seated in one of the plurality of seats.

18. The modular organization kit of claim 17 further comprising a plurality of connection members, wherein the plurality of arm members includes a second arm member having a proximal end portion and a distal end portion, the proximal end portion coupled with the second end portion using a first connection member of the plurality of connection members.

19. The modular organization kit of claim 17 further comprising a securing mechanism, wherein the other of the first collar member or the second collar member has an opening defined therethrough that is sized to receive the securing mechanism

20. A method of coupling at least one accessory to a seat pedestal, the method comprising:
coupling at least one base assembly to a seat pedestal, each base assembly adjustable between a disengaged configuration and an engaged configuration;
coupling an arm assembly to a first base assembly of the at least one base assembly, the arm assembly including a first arm member rotatable about the seat pedestal when the first base assembly is in the disengaged configuration and securely positioned relative to the seat pedestal to extend radially from the seat pedestal in one of a plurality of directions when the first base assembly is in the engaged configuration; and
coupling at least one accessory to the arm assembly.
